(19) United States
(12) Patent Application Publication
(10) Pub. No.: US 2011/0030218 A1
(43) Pub. Date: Feb. 10, 2011

(54) TUBE CUTTING APPARATUS AND METHOD

(76) Inventors: Manfred Schmid, Leinfelden-Echterdingen (DE); Rainer Käsinger, Haiterbach (DE)

Correspondence Address: MICHAEL BEST & FRIEDRICH LLP, 100 E WISCONSIN AVENUE, Suite 3300, MILWAUKEE, WI, 53202, US

(21) Appl. No.: 12/850,331

(22) Filed: Aug. 4, 2010

(30) Foreign Application Priority Data
Aug. 4, 2009 (DE) 102009036006.9

(51) Int. Cl. B23P 15/26; B21B 1/38

(52) U.S. Cl. 29/890.053; 72/203

(57) ABSTRACT

A process for producing tubes (1), in particular for use in heat exchangers, from at least one metallic strip on a rolling mill train, wherein the strip, on a rolling mill train, is provided with predetermined breaking points, deformed and brought together to form the tube and finally the tubes are torn off at the predetermined breaking points between two pairs of rolls having a speed difference. The process is improved, in terms of the tearing off of individual tubes, in that an areal compressive force (Ak) is applied to the tube at least at the moment of tearing off and a sufficient tearing force (Rk) is produced and transmitted to the tube to be torn off.

### RELATED APPLICATIONS

This Application claims priority to German Patent Application No. 10 2009 036 006.9, filed Aug. 4, 2009, the entire contents of which are hereby incorporated by reference herein.

### BACKGROUND

The invention relates to a process for producing tubes, for example for use in heat exchangers, from at least one metallic strip on a rolling mill train.

A production process and a corresponding rolling mill train are described in DE 10 2006 033 568 A1. In said application, individual tubes are broken off or cut off at perforations or predetermined breaking points present in the strips.

With respect to the tearing off of the tubes U.S. Pat. No. 5,653,022 describes a pair of pull rollers and a pair of guide rollers, between which individual tubes are torn off. In the case of pairs of rolls of this type, undesirable slippage may occur during the tearing off. In said document, the tubes themselves are of an extruded type, i.e. they have not been produced from at least one metallic strip.

In EP 714 342 B1, extruded tubes are likewise torn off between a stationary clamp assembly and a movable clamp assembly. The clamp assembly moves rectilinearly in the direction of the tube.

### SUMMARY

The object of the present invention is to improve the above-defined production process with respect to the tearing off of individual tubes by means of pairs of rolls. In particular, slippage between the tube and the pairs of rolls should be prevented or the probability of slippage movements occurring should at least be reduced significantly.

One aspect of the production process provides for an areal compressive force to be applied to the tube at least at the moment of tearing off and for a sufficient tearing force to be transmitted to the tube to be torn off.

A rolling mill train for carrying out a process for producing tubes from at least two “endless” metallic strips, wherein the rolling mill train is equipped with pairs of rolls and has at least one station for introducing predetermined breaking points into the strips, a section for deforming the strips to form the tube, and a tearing-off device for tubes which comprises at least two pairs of rolls, is characterized in that at least the second pair of rolls, lying in the conveying direction of the tube, of the tearing-off device is formed from at least two pairs of rolls, the rolls of which are connected by means of at least two transport belts.

It goes without saying that the tearing-off device can also be used, for example, for extruded tubes or tubes produced in another way.

Since, according to this proposal, areal compressive forces and thus significantly greater compressive forces are transmitted to the tube by means of the transport belts, slippage can be avoided. Accordingly, it is also possible for greater tearing forces to be transmitted to the tube. Overall, therefore, this proposal also contributes to the fact that the rolling mill train can be operated reliably at a greater speed, and this is a factor which increases productivity.

As a result, individual tubes which have no dents or other defects at all on the tube ends and are therefore ideal for use as tubes in a heat exchanger are produced.

The invention will now be described with reference to the accompanying drawings in two exemplary embodiments. The description which follows may contain information, features and advantages that may prove to be particularly significant at a later point in time.

### BRIEF DESCRIPTION OF THE DRAWINGS

FIG. 1 shows a rolling mill train in principle with a tearing-off device at the end.

FIGS. 2 and 2a show a side view of the tearing-off device according to the invention with upstream pairs of rolls.

FIG. 3 shows a second exemplary embodiment.

FIG. 4 shows a tube in cross section.

FIG. 5 shows, in the form of a perspective view, a sectional view and a detail from the sectional view, a pair of rolls for producing predetermined breaking points.

### DETAILED DESCRIPTION

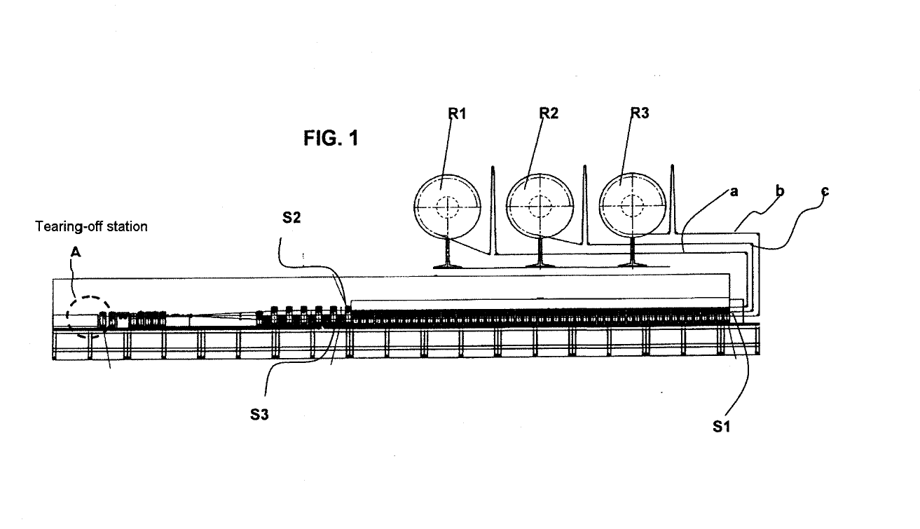

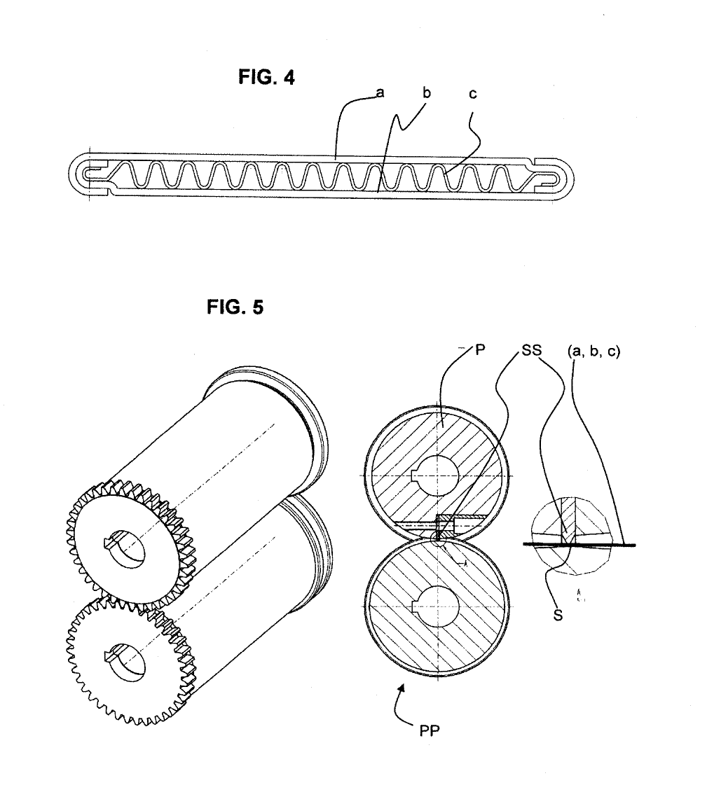

Since the exemplary embodiment shown refers to three-part tubes (FIG. 4, two wall parts a, b and an inner insert c), it can be gathered from FIG. 1 that three strip rolls R1, R2, R3 are present as starting material. These are sheet aluminum. The strip roll R1 generates part a, the strip roll R2 generates part c and, finally, the strip roll R3 generates part b of the flat tube 1. As shown in the illustration, in each case one very large loop is present in the strip directly behind the strip rolls R1, R2, R3, and these loops serve to compensate different speeds or else stoppages of the strip. Depending on requirements, a plurality of loops can also be provided, which is also the case from a practical point of view. The first predetermined breaking point station S1 is already situated directly at the start of the rolling mill train, and said station introduces the predetermined breaking points into the strip roll R2 (part c). Part c is then deformed by means of pairs of rolls (not shown in detail) over a corresponding distance in such a manner as to provide the configuration shown in FIG. 4. The first predetermined breaking point station S1 is thus adjoined by a section of the rolling mill train in which one strip material is deformed so as to form part of the subsequent tube. The strip rolls R1 (part a) and R3 (part b) merely roll through said distance without being significantly deformed there. The upper strip roll R1 then reaches the second predetermined breaking point station S2. This is followed at a short distance by the third predetermined breaking point station S3, through which the lower strip roll R3 runs in order to be correspondingly provided with predetermined breaking points S. The edge deformations on parts a and b are then formed and part c is mounted in between parts a and b (not shown in detail). However, reference can be made in this regard to patent application DE10-2006-029 378.9. In doubt, the entire content of said application should be regarded as disclosed at this point. Approximately in said section, the predetermined breaking points 3 in the three parts a, b, c are also brought into alignment, with known open-loop and closed-loop control means (not shown) being used for this purpose. As is well known to a person skilled in the art, said section should be situated upstream from the region in which parts a, b, c have already been connected to one another and are in rigid physical contact. When parts a, b, c are subsequently joined to form the tube 1, then an endless tube 1 is initially provided (as shown in the cross section in FIG. 4), from which the individual tubes 1 are then to be separated.

The three predetermined breaking point stations S1, S2 and S3 (FIG. 5) can be of identical design. However, a single station which incorporates all three stations may also be present. In this case, in contrast to the description above, the stations or devices are all located at approximately the same height. The number and physical positioning of predetermined breaking point stations S is dependent on the individual application, for example on the specific design of the tube 1. In the exemplary embodiment, the predetermined breaking point stations S1, S2, S3 comprise a pair of rolls PP. One (the lower) roll P preferably runs freely and guides part a, b or c, which is transported between the rolls P. The other (upper) roll P is formed with a projecting predetermined breaking point punch SS. Open-loop and closed-loop control means known per se are used to hold the other roll P with the predetermined breaking point punch SS in a waiting position, in which the predetermined breaking point punch SS is not in engagement. In this position, the predetermined breaking point punch SS is located horizontally on the roll P. The means mentioned then ensure that the roll P is moved abruptly with a high rotational speed so as to come into the action position shown, in which the predetermined breaking point punch SS is in engagement and the predetermined breaking points 3 are produced. The rotational speed or the peripheral speed of the rolls P is preferably higher than the transport speed of the strip, in order to ensure that the strip does not curl up.

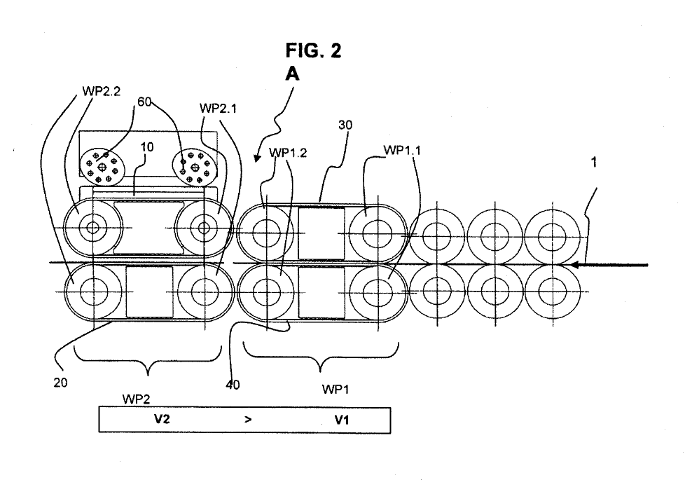

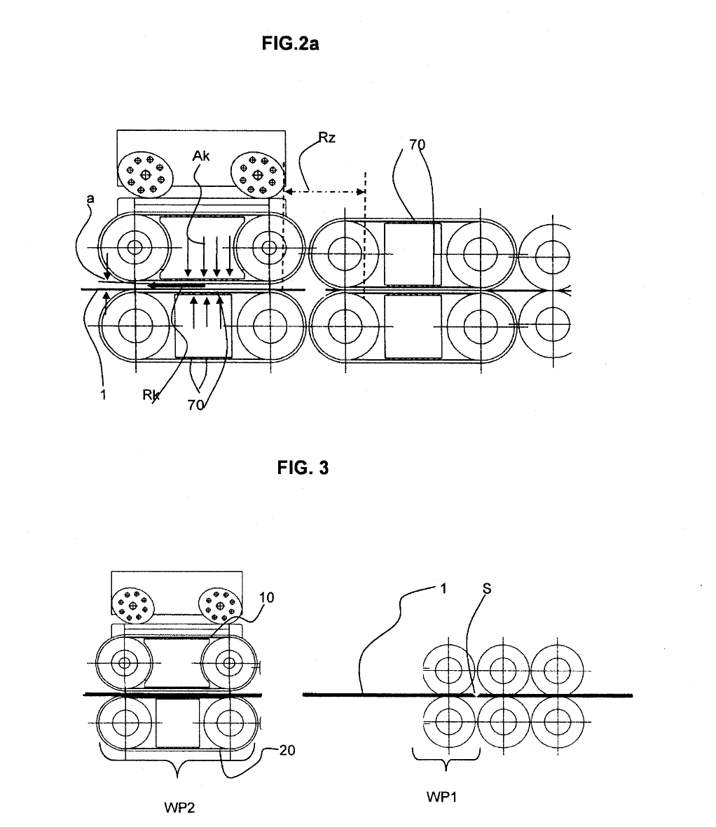

FIGS. 2 and 2a show an exemplary embodiment in which each of the two pairs of rolls WP1 and WP2 has been formed in each case from two pairs of rolls WP1.1 and WP1.2 and, respectively, WP2.1 and WP2.2.

The upper rolls of the second pair of rolls WP2 in the figure are connected by a first transport belt 10 and the lower rolls in the figure have a second transport belt 20. The first pair of rolls WP1 has been equipped accordingly, with third and fourth transport belts 30 and 40 being present there. Two eccentrics 60 have been indicated above the second pair of rolls WP2. Camshafts or pressure-activatable working cylinders can also be involved here, and these are used to increase the compressive force Ak, for example at the moment when the tube 1 is torn off. The camshafts 60 are activated owing to corresponding pulses. This configuration provides advantageous functions. For example, firstly greater tearing forces Rk can be transmitted because the areal contact surface on the tube 1 is considerably larger. Secondly, it is also possible to increase the areal compressive forces slightly since the at least slightly elastic upper and lower transport belts 20, 30 can be pressed against one another by simple means between the rolls.

A sufficient areal compressive force Ak can be transmitted to the tube 1 using the means described above at least at the moment when the tube 1 is torn off, and the friction between the transport belts 10, 20 and the tube also makes it possible to transmit a tearing force Rk to the tube 1.

In an exemplary embodiment which is not shown but nevertheless presently preferred, the means mentioned (eccentrics 60 or the like) are not present, i.e. a sufficiently great, but substantially static areal compressive force Ak is constantly transmitted. The areal compressive force Ak can be set by means of a spindle or the like. It therefore acts constantly—in contrast to the first exemplary embodiment—and not just at the moment of tearing off. The magnitude of said force has to be finely tuned to the compressive force in the first pair of rolls WP1. This also means that the distance a which can be seen in FIGS. 2 and 3 between the upper and lower transport belts 10 and 20 does not have to be present in these embodiments which are not shown. A further result of this is that the second pair of rolls WP2 or the drive motor thereof (not shown) receives a rotational acceleration pulse, at the moment of tearing off, in order to produce the tearing force Rk and to transmit the latter by means of the friction mentioned. A sensor (not shown) is present for this purpose and detects a predetermined breaking point S situated between the pairs of rolls WP1 and WP2 and triggers a corresponding rotational acceleration pulse in the drive motor of the second pair of rolls WP2.

FIG. 2a shows an enlargement of an excerpt of FIG. 2, and it should be clear from FIG. 2a that it is advantageous to arrange a series of rollers 70 on the inner side of the transport belts 10, 20, 30, 40 that improve the uniformity of the transmission of the areal compressive force Ak to the tube 1. Only the upper or lower peripheral sections of the rollers 70 can be seen in FIG. 2a. A possible tearing-off zone Rz, in which the tearing off operation according to the proposal is to take place, has also been marked in FIG. 2a.

The rolls can also be designed in the manner of gearwheels or have a ribbed surface. The inner side of the transport belts 10, 20, 30, 40 may then have a structure which corresponds to the teeth or to the ribbing. This affords an improved transmission of force from the rolls to the transport belts. In addition, as mentioned, suitable drive units, servomotors or the like are also present for the rolls, but have not been depicted.

The tearing force is produced by means of the second pair of rolls WP2, since the finished tube comes from the right-hand side in the image. As mentioned, the rotational speed V2 of the second pair of rolls can also be regulated accordingly. In order to produce the tearing force Rk, said rotational speed has to be higher than the rotational speed V1 in the first pair of rolls. The individual tubes 1 are torn off between the pairs of rolls WP1 and WP2 at the predetermined breaking point S located there at that time. In this case, the predetermined breaking points S are notches in the strips, although perforations also allow the same effects. It can be seen that the tearing force Rk acts approximately in the longitudinal direction of the tube 1, whereas the areally applied compressive force Ak acts approximately perpendicularly thereto, for example perpendicularly on the two wall parts a and b in the tube shown in FIG. 4. Since the tube has an inner insert c, it is also sufficiently stable to absorb high compressive forces without being impaired. Since the compressive force is applied over a very large area, it is also possible to tear off less stable tubes cleanly in the proposed manner.

FIG. 3 shows a second exemplary embodiment, in which merely the second pair of rolls WP2 has been configured as described. The first pair of rolls WP1 can be a simple pair of rolls. The surfaces of the rolls can be covered with rubber. In FIG. 3, only a few reference symbols have been used because the elements shown correspond to those in FIGS. 2 and 2a. The relatively large distance between the pairs of rolls WP1 and WP2, which can be seen in FIG. 3, is actually not intended but rather arises as a result of the drawing.

What is claimed is:

1.-21. (canceled)

22. A method of producing heat exchanger tubes comprising:
providing at least one metallic strip on a rolling mill train;
forming predetermined breaking points on the at least one metallic strip on the rolling mill train;
deforming the at least one metallic strip to form a tube;
tearing the tube at the predetermined breaking points between a first pair of rolls and a second pair of rolls having a different speed to form a plurality of tubes;
applying an areal compressive force to the tube at least at a moment of tearing the tube; and
transmitting a sufficient tearing force to the tube.

23. The method of claim 22, wherein applying the areal compressive force includes exerting the areal compressive force on the tube between two transport belts between which the tube is transported.

24. The method of claim 23, wherein transmitting the sufficient tearing force to the tube includes transmitting the tearing force between the two transport belts and the tube on account of friction.

25. The method of claim 23, wherein applying the areal compressive force includes moving at least one of the transport belts toward the tube.

26. The method of claim 22, further comprising regulating the areal compressive force applied to the tubes by the second pair of rolls.

27. The method of claim 22, further comprising setting the areal compressive force to approximately a maximum at the moment of tearing.

28. The method of claim 22, wherein applying the areal compressive force includes exerting an approximately static areal compressive force on the tube.

29. The method of claim 22, further comprising transmitting a rotational acceleration pulse to a drive motor of the second pair of rolls so that the speed difference between the first pair of rolls and the second pair of rolls occurs only at the moment of tearing the tube.

30. The method of claim 22, wherein providing the at least one metallic strip includes providing at least two generally endless metallic strips.

31. The method of claim 23, wherein the two transport belts are supported by means of support rollers in order to improve the uniformity of the transmission of the areal compressive force.

32. A rolling mill train for carrying out a process for producing tubes from at least two endless metallic strips comprising:
at least one station for introducing predetermined breaking points into the strips;
a section for deforming the strips to form a tube; and
a tearing-off device for the tubes that includes a first pair of rolls (WP1) and a second pair of rolls (WP2),
wherein at least the second pair of rolls (WP2), lying in a conveying direction of the tube, of the tearing-off device is formed from at least two pairs of rolls (WP2.1, WP2.2), the rolls of which are connected by at least a first transport belt (10) and a second transport belt (20).

33. The rolling mill train of claim 32, further comprising support rollers (70) for the first transport belt and the second transport belt that are arranged between the two pairs of rolls (WP2.1 and WP2.2).

34. The rolling mill train of claim 32, wherein the first pair of rolls (WP1) also includes at least two pairs of rolls (WP1.1; WP1.2).

35. The rolling mill train of claim 32, wherein rolls of the first pair of rolls (WP1) are connected by a third transport belt (30) and a second transport belt (40).

36. The rolling mill train of claim 35, wherein each roll has surface ribbing and an inner side of the transport belts (10, 20, 30, 40) have a structure which corresponds to the ribbing.

37. The rolling mill train of claim 35, wherein the tube passes between the two transport belts (30, 40) of the first pair of rolls and between the two transport belts (10, 20) of the second pair of rolls.

38. The rolling mill train of claim 32, wherein a surface on an outer side of the first and second transport belts is selected such that the tube is transported by sufficient friction between the tube and the first and second transport belts and tensile forces can be transmitted to the tube.

39. The rolling mill train of claim 32, wherein an areal compressive force is applied to the first and second transport belts.

40. The rolling mill train of claim 39, wherein the areal compressive force is at least one of static, surges, and subsides dynamically.

41. The rolling mill train of claim 39, wherein in the case of a static areal compressive force, a sensor detects predetermined breaking points situated between the pairs of rolls (WP1, WP2) and a drive motor of the second pair of rolls (WP2) receives a rotational acceleration pulse in order to produce a tearing force.

42. A tearing-off device for tubes as a constituent part of a rolling mill train, the device comprising:
a first pair of rolls (WP1); and
a second pair of rolls (WP2),
wherein at least the second pair of rolls (WP2), lying in a conveying direction of the tubes, of the tearing-off device is formed from at least two pairs of rolls (WP2.1; WP2.2), the rolls of which are connected by means of at least a first and a second transport belt (10, 20).
